(19) United States
(12) Patent Application Publication
(10) Pub. No.: US 2007/0016911 A1
(43) Pub. Date: Jan. 18, 2007

(54) ERROR PROCESSING SYSTEM

(75) Inventors: Keith A. Cyktor, Birdsboro, PA (US); David Kline, Paoli, PA (US); Donald Ayres, Pottstown, PA (US); Sean Kelly, Honey Brook, PA (US); James William McInnis, Elverson, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS HEALTH SERVICES CORPORATION, MALVERN, PA (US)

(21) Appl. No.: 11/423,732

(22) Filed: Jun. 13, 2006

Related U.S. Application Data
(60) Provisional application No. 60/689,904, filed on Jun. 13, 2005.

(51) Int. Cl. G06F 9/46

(52) U.S. Cl. 719/313

(57) ABSTRACT

An error processing system in a system for communicating messages from a plurality of source executable applications to a plurality of destination executable applications includes a repository for centrally storing data identifying errors encountered by the plurality of different destination executable applications in processing data in messages from one or more of the source executable applications. Such an identified error may be encountered by an individual destination executable application during partially successfully processing of data in a first message received from a source executable application. A user interface initiates generation of data representing a single display image including data identifying, at least one error encountered by a particular destination executable application during partially successfully processing data in a first message, the first message, and the particular destination executable application.

This is a non-provisional application of provisional application Ser. No. 60/689,904 by Keith A. Cyktor, filed Jun. 13, 2005.

### FIELD OF THE INVENTION

The present invention relates to an error processing system for use in a system for communicating messages from source processing systems to destination processing systems, and in particular to an error tracking and processing system for use in a transaction data processing system.

### BACKGROUND OF THE INVENTION

Networking permits multiple processing systems to be interconnected, allowing communications and sharing of data between them. Data is passed by communicating messages from one processing system, termed a source processing system, via a network to another processing system, termed destination processing system. Messages contain inter alia the data to be passed, data representing the identity of the source processing system, and data representing the identity of the destination processing system. The network routes the message from the source processing system to the destination system. The message may, for example, represent a request that a task to be performed by the destination processing system at the behest of the source processing system.

For example, a healthcare provider may provide a healthcare service to a patient. Payment for this service may come from a number of sources, termed payors: personal healthcare insurance of the patient, healthcare insurance provided by the patient's employer; healthcare insurance provided by the government (VA, Medicare, Medicaid, etc.); and/or a guarantor responsible for any charges not paid by another payor. As described above, the healthcare provider and any or all of the payors may have processing systems for processing healthcare payments. In such a case, a message may be sent from a source processing system to a destination processing system requesting an action be performed relating to payment for the healthcare services rendered to the patient by the healthcare provider.

More specifically, in the illustrated embodiment, the healthcare provider processing system may initially send a claim to the patient's primary insurance company by sending a message to the primary insurance company processing system containing data identifying, among other things, the patient, the healthcare provider, and the healthcare service provided to the patient. The primary insurance company processing system verifies: that the patient has a policy with the insurance company and that the policy is paid up; that the healthcare provider is approved for payment by the insurance company; that the healthcare service is one for which the insurance company provides payment, etc. When all necessary aspects of the claim have been verified, reimbursement may be sent to the healthcare provider. The insurance company processing system may, in turn, send messages to processing systems at other locations, such as other insurance companies for coordination of benefits and/or an electronic payment clearing house for sending the reimbursement from the insurance company bank account to the healthcare provider bank account.

An error may occur in the processing of the tasks requested by the messages. If an error occurs, this indicates that the task has not been successfully performed, or has been partially successfully performed. Such errors must be investigated, corrective action taken, and the tasks resubmitted until they are successfully performed.

Error processing systems have been developed to process such errors. Existing error processing systems deal with transactions at the message communication or database level and typically ignore executable application level errors. Such systems ensure that communicated data is intact and readable. However, data can be communicated from one processing system to another intact and readable, but, there may be problems with the content or composition of that data. For example, a communicated zip code may have nine digits, but the destination executable application may be able to handle the traditional five digits but not the additional four digits. Or the data may be missing required information making the data useless to the destination executable application. In these cases, because the destination processing system accurately receives the data in the message communicated to it from the source processing system, and because the destination processing system positively acknowledges receipt of that data, rejecting the data may not be a permitted option. However the task requested by that message cannot be completely successfully performed.

In existing error processing systems, a user manually gathers information from several processing systems in order to ascertain whether a transaction has been successfully processed. These processing systems may include the source processing system originating the data, an intermediate processing system, termed an integration system, and/or the destination processing system.

In the event a transaction error is detected, a user responsible for resolving the issue typically accesses the respective log files of the executable applications which generated the error to determine what application errors are recorded. The message initiating the transaction also needs to be located to examine the actual transaction data. This process requires the user to concurrently access multiple executable applications on respectively different processing systems, and/or to physically print the information from the different processing systems. This, in turn, requires a user to have access to, and knowledge of, multiple executable applications, as well as entailing increased administrative support to maintain user access to the multiple applications. To effectively access this data the user needs to keep current with executable application enhancements and updates. This increases costs and slows problem resolution. A user may also need to view data from several sources and create a composite view of the data. However, difficulties in acquiring concurrent access to multiple executable applications in multiple processing systems possibly at multiple physical locations means a user may develop an incomplete or inaccurate understanding of the problem which led to the error.

In summary, the existing system methods are slow and cumbersome when major issues arise and result in expanded testing cycles. In addition, application knowledge has to be maintained in the face of staffing changes and upgrade of executable applications. A system according to invention principles addresses these deficiencies and related problems

### BRIEF SUMMARY OF THE INVENTION

In accordance with principles of the present invention, an error processing system in a system for communicating messages from a plurality of source executable applications to a plurality of destination executable applications includes a repository for centrally storing data identifying errors encountered by the plurality of different destination executable applications in processing data in messages from one or more of the source executable applications. Such an identified error may be encountered by an individual destination executable application during partially successfully processing of data in a first message received from a source executable application. A user interface initiates generation of data representing a single display image including data identifying, at least one error encountered by a particular destination executable application during partially successfully processing data in a first message, the first message, and the particular destination executable application.

A system according to principles of the present invention, advantageously compiles and presents error information at a common point to a responsible user so that user may access the information quicker. The user does not have to concurrently logon to multiple applications and, thus, can effectively monitor more applications. The user also does not have to be able to navigate through multiple applications and is not required to understand the low-level interface topography.

### BRIEF DESCRIPTION OF THE DRAWING

In the drawing:

FIG. 1 is a block diagram of a system according to principles of the present invention; and

FIG. 2 through FIG. 7 illustrate screen displays for a user interface according to principles of the present invention.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprise any combination of, hardware, firmware, and/or software.

An executable application, as used herein, comprises code or machine readable instructions for conditioning the processor to implement predetermined functions, such as those of an operating system, transaction data monitoring and error processing system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by the display processor under the control of the processor. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to the processor. The processor, under control of the executable procedure or executable application manipulates the UI display images in response to the signals received from the input devices. In this way, the user interacts with the display image using the input devices, enabling user interaction with the processor or other device.

A form, as used herein, is a type of UI display image. A form UI display image includes display elements, such as textual display, which prompt the user to enter particular information; and display elements, such as text boxes, check boxes etc., into which the user, using the input devices, may enter the particular information.

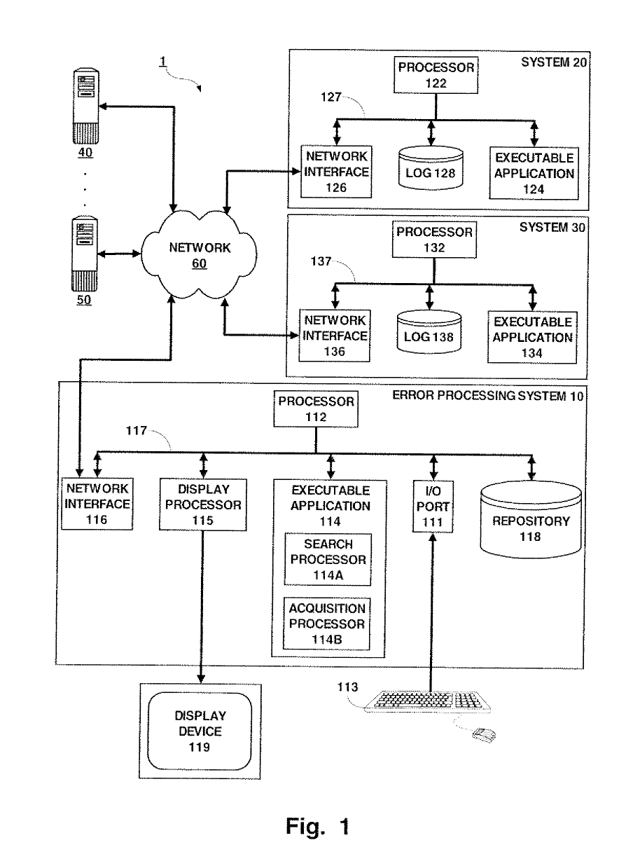

FIG. 1 is a block diagram of a system 1 according to principles of the present invention. In FIG. 1, a plurality of processing systems 10, 20, 30, 40, 50 are bidirectionally coupled to a network 60. The network 60 is typically a wide area network, such as the Internet, but may include other similar networks including local area networks (LANs), intranets, and so forth. The processing system 10 operates as an error processing system, in a manner described below, and includes a processor 112 bidirectionally coupled to a bus 117. The bus 117 is also bidirectionally coupled to a network interface 116, a display processor 115, a memory storing an executable application 114, an input/output (I/O) port 111, and a repository 118. The network interface 116 is bidirectionally coupled to the network 60. An output terminal of the display processor 115 is coupled to an input terminal of a display device 119 and an input terminal of the I/O port 111 is coupled to an output terminal of a user input device 113. In FIG. 1, the input device is illustrated as a keyboard and mouse, but one skilled in the art understands that any user input device, such as a light pen, touch screen or any other means allowing a user to provide data to the processor 112 may be used instead of, or in addition to, a keyboard and/or mouse.

Respective processing systems 20 and 30 include a processor (122, 132) bidirectionally coupled to a bus (127, 137). The bus (127, 137) is also bidirectionally coupled to a network interface (126, 136), a log file (128, 138) and a memory storing an executable application (124, 134). The network interface (126, 136) is bidirectionally coupled to the network 60. A plurality of other processing systems 40, 50 are implemented similarly to processing systems 20 and 30, and are also bidirectionally coupled to the network 60.

In operation, the plurality of processor systems 10, 20, 30, 40, 50 interoperate by communicating messages among each other via the network 60. A message is a self-contained set of data which is to be sent from a source location to a destination location. More specifically, in the illustrated embodiment, a message may be formed by an executable application (e.g. 124), termed the source executable application, in one processing system (e.g. 20). The message is sent to an executable application (e.g. 134), termed the destination executable application, in a different processing system (e.g. 30) via the network 60. One skilled in the art understands that an executable application (e.g. 124, 134) may operate as a source executable application for one message and as a destination executable application for a different message. Thus, the system 1, as a whole, communicates messages from a plurality of source applications (124, 134) to a plurality of destination executable applications.

In general, such messages are sent to request that a destination executable application perform a task at the behest of a source executable application. Such a task is termed a transaction. More specifically, the processing system 20 may be located in a billing department of a healthcare facility (e.g. Hospital A), and the processing system 30 may be located in a claims department of a healthcare insurance company (e.g. Ins. Co. B). The executable application 124 in the billing department processing system 20 interacts with a user to generate data representing a claim for reimbursement from the healthcare insurance company for medical services provided to a patient. The claim data includes data elements such as e.g. data identifying the patient, data identifying the healthcare service provided to the patient, data identifying the healthcare insurance policy of the patient, and so forth. The executable application 124 generates a message containing the claim data. The message may also include other data elements including: data uniquely identifying the message (i.e. a message identifier); data identifying the source processing system 20; data identifying the source executable application 124, data identifying the destination processing system 30, data identifying the destination executable application 134, and so forth. These data elements are arranged in a predetermined data format or protocol. For example, the message may comprise a HealthLevel 7 (HL7) protocol compatible transaction message. This message is supplied to the network 60 through the network interface 126 under the control of the executable application 124. The network 60 routes the message to the insurance company processing system 30.

The executable application 134 in the insurance company processing system 30 conditions the network interface 136 to receive the message from the network 60. In general, the executable application 134 extracts the claim data from the message, and processes that data to determine whether reimbursement should be provided to the healthcare facility, and if so, how much the reimbursement should be. Initially, the message and message data is checked by the executable application 134 for errors. Specifically the message and message data elements are checked to determine if the format or protocol of the message and of the individual data elements is compatible. The message data elements are also checked to determine if mandatory data elements are missing; and/or if surplus data elements are present.

For example, if the message is expected to be in the HL7 format, but the received message is not, the executable application 134 generates an error, and further processing is not possible. Data representing this error is stored in the log 138 by the executable application 134. If the message format is compatible, the data elements are checked to determine if required data elements are present. For example, a claim must include patient identification information in a format compatible with processing by the executable application 134. If patient identification is not present, or the format of that information is incompatible, the identification of the patient cannot be determined and a claim cannot be processed. In this case, the executable application generates and error, and data representing this error is stored in the log 138 by the executable application 134. Similarly, data elements are checked to determine if surplus data elements are present. If a data element is present in the message data which is not recognized by the executable application, i.e. if a surplus data element is present, the executable application 134 generates an error, and data representing that error is stored in the log 138 by the executable application 138.

When the message and claim data elements are verified to be in a compatible format or protocol with required data elements present, and no surplus data elements present, the executable application 134 processes the claim data in the message to determine whether to reimburse the healthcare facility and how much the reimbursement is to be. For example, the identification information of the patient is used to determine of the patient has an insurance policy with the insurance company. The patient policy is checked to determine if the healthcare service provided to the patient is covered under the insurance policy. The identification information of the healthcare provider is checked to determine if the healthcare provider is entitled to reimbursement and/or what level of reimbursement is available.

These checks may also result in errors being detected, and logged in the log file 138. If, for example, the patient does not have a policy with the healthcare insurance company, or if the healthcare provider is not entitled to reimbursement, the executable application 134 generates an error, and data representing the error is stored in the log 138 by the executable application 134. Respective common log files 128, 138 may be maintained within the respective processing systems 20, 30, or a separate log file may be maintained by the respective executable applications 124, 134 within the processing systems 20, 30.

If no errors are detected, and reimbursement is to be made to the healthcare facility, a reply message is formed by the executable application 134 containing data representing the reimbursement to be paid by the insurance company to the healthcare provider. This data may include: data specifying the amount of the reimbursement, data identifying a financial transaction transferring the reimbursement to the healthcare provider from the insurance company, and so forth. Other data may be included in the message, such as: data representing the identity of the source processing system 30, data representing the identity of the source executable application 134, data representing the identify of the destination processing system 20, data representing the identity of the destination executable application 124, and so forth.

If errors are detected by the executable application 134, corresponding entries are made in the log 138 specifying the type of errors indicating, for example: (a) a message or data element format incompatibility, (b) a missing mandatory data element, and/or (c) a surplus data element. The entries in the log 138 contain data elements describing the error, and include: data representing the date and time of the error, data representing the identity of the patient, data representing the type of error, data describing the error, data representing the identity of the destination application, data representing the identity of the message (message identifier) causing the error, data representing the identity of the source executable application. Other data may also be stored in the entry, including data representing the identity of the source processing system, data representing the identity of the destination processing system, and so forth.

In either case, i.e. whether an error is detected or not, the executable application 134 forms a message containing the data generated by the executable application 134 (i.e. data representing a successful transaction or data representing an error) in a predetermined protocol or format, and provides it to the network interface 136. The network interface 136 provides the message to the network 60, which routes that message to the healthcare provider processing system 20.

More than one message may be generated in a single transaction. For example, the healthcare facility processing system 20 may generate respective messages to more than one insurance company if the patient is covered under a policy from more than one insurance company (such as in a case where a patient's employer provides insurance coverage, a patient's spouse's employer provides insurance coverage, and government insurance coverage is available). Also, the insurance company processing system may send a plurality of messages to the other insurance companies to coordinate benefits. The insurance company may also send a message to a financial institution to initiate transfer of the reimbursement from the insurance company to the healthcare facility. Error messages returned after sending such messages are also logged in the log 138. Such error messages must be analyzed and resolved.

The error processing system 10 accesses the error representative data in the log files 128, 138 in the respective processing systems 20, 30. That is, data identifying errors encountered by the plurality of different destination executable applications (e.g. 134) is derived from individual error logs (e.g. 138) associated with the corresponding individual destination executable applications 134. The error processing system 10 includes an acquisition processor executable procedure 114b. The acquisition processor executable procedure 114b, when executed by the processor 112, conditions the error processing system 10 to operate as an acquisition processor for acquiring the data identifying errors encountered by the plurality of different destination executable applications (e.g. 134) for central storage in the repository 118.

More specifically, in the illustrated embodiment, the acquisition processor executable procedure 114b forms a message to be communicated to another processing system (e.g. 20, 30) requesting that that processing system (e.g. 20, 30) send data in the log file (e.g. 128, 138) to the error processing system 10. This message is supplied to the network interface 116, which sends it to the network 60. The network 60 routes the message to the desired processing systems (e.g. 20, 30). The network interfaces 126, 136 in those processing systems 20, 30 receive the message. The message is processed by the executable application 124, 134, and contents of the log files 128, 138 are returned to the error processing system 10 via the network interfaces 126, 136, network 60, and network interface 116. The acquisition executable procedure 114b receives the returned data from the other processing systems 20, 30, and stores it in the repository 118.

The repository 118 centrally stores data identifying errors encountered by the plurality of different destination executable applications (e.g. 134) in processing data in messages from one or more source executable applications (e.g. 124). An identified error of an individual destination executable application 134 is encountered during partially successfully processing data in a first message received from a source executable application 124. That is, a portion of the task requested by the source executable application 124 may be performed properly, while the remainder of the task produces an error.

More specifically, data in a message communicated from a source executable application (e.g. 124) in a source processing system (e.g. 20) may require processing by more than one destination executable application (e.g. 134) in more than one destination processing system (e.g. 30, 40, 50). In some cases, message data may be concurrently communicated in respective messages to more than one destination executable application (e.g. 134) in respectively corresponding destination processing systems (e.g. 30, 40, 50). In some cases, a message may be communicated to a destination processing system 30, 40, 50, and the data in the message may require processing by more than one executable application (e.g. 134) in that processing system (e.g. 30, 40, 50). In some cases, a message may be communicated to a first destination processing system (e.g. 30), but a first executable application (e.g. 134) processing the message data in the first destination processing system 20 may need to communicate a message containing data to a second executable application in a second destination processing system (e.g. 40, 50) to request processing of that data.

In general, if the required processing of the data by the destination executable applications (e.g. 134) in the respectively corresponding destination processing systems (e.g. 30, 40, 50) is successfully performed, then the data in the original message communicated from the original source executable application (e.g. 124) in the corresponding processing system (e.g. 20) is considered to be completely successfully processed. It is possible, however, for the processing of data by some of the associated executable applications to produce an error and processing of the data by other associated executable applications to be successful. In this case, the data in the original message communicated from the original source executable application (e.g. 124) in the corresponding processing system (e.g. 20) is considered to be partially successfully processed.

For example, a billing executable application (e.g. 124) in a healthcare facility processing system (e.g. 20) may concurrently communicate claim data in messages to processing systems (e.g. 30, 40, 50) of respective healthcare insurance companies associated with a patient to whom healthcare services are rendered. If data in the message is successfully processed by the respective claim processing executable applications (e.g. 134) in the different insurance company processing systems (e.g. 30, 40, 50), the message is considered to be completely successfully processed. If, however, an executable application (e.g. 134) in one or more of the destination processing systems (e.g. 30, 40, 50) produces an error when processing the data in the message received by the processing system (e.g. 30, 40, 50), the data in the message is considered to be partially successfully processed and data representing the error is stored in the log (e.g. 138) by the executable application (e.g. 134) producing the error.

Continuing the example, data in a message received by a healthcare insurance company processing system (e.g. 30) may be processed by: (a) a first executable application (e.g. 138) which, for example, checks the received data to ensure that the patient has a policy with the insurance company, that the healthcare service is covered by the policy, etc.; (b) a second executable application (not shown) which, for example, determines the reimbursement due to the healthcare facility; and/or (c) other executable applications (also not shown) performing other tasks. If data in the message is successfully processed by the respective executable applications (e.g. 134), the message is considered to be completely successfully processed. If, however, one or more of the executable applications (e.g. 134) produces an error when processing the data in the received message, the data in the message is considered to be partially successfully processed, and data representing the error is stored in the log (e.g. 138) by the executable application (e.g. 134) producing the error.

Further continuing the example, the executable application (e.g. 134) in the healthcare insurance company processing system (e.g. 30) which determines the reimbursement due to the healthcare facility may also arrange to transfer these funds from the insurance company bank to the healthcare facility bank. This executable application (e.g. 134) may generate a message to be sent, via the network interface 136 and network 60, to a destination executable application (not shown) in the processing system (e.g. 40, 50) in the bank of the insurance company authorizing the bank to make the transfer of money to the bank of the healthcare facility. If the executable application in the bank processing system (e.g. 40, 50) successfully processes the data in this message, the data in the original message from the healthcare facility to the insurance company is considered to be completely successfully processed. If, however, the bank processing system produces an error when processing the data in its received message, the data in the original message is considered to be partially successfully processed and data representing the error is stored in the log (not shown) in the bank processing system (e.g. 40, 50).

In short, a message from a source executable application in a source processing system to a destination executable application in a destination processing system may result in one or more destination executable applications performing one or more tasks. If the executable applications perform the tasks successfully, the data in the message is considered to be completely successfully processed. If performance of one or more of the tasks produces an error in the executable application, the data in the message is considered to be partially successfully processed and data representing the error is stored in a log file by the executable application.

As described above, a user interface (UI) permits a user to interact with the processor 112 via images displayed on the display device 119 and operation of the input devices 113. In the illustrated embodiment, the UI initiates generation of data representing a single display image including: (a) data identifying at least one error encountered by a particular destination executable application (e.g. 134) during partially successfully processing data in the first message; (b) data identifying the first message (i.e. the message identifier); and (c) data identifying the particular destination executable application 134. Other data may also be stored in the repository 118. For example, some messages include data elements to be stored in a database, or to update data already stored in a database. In a healthcare insurance company processing system (e.g. 30), for instance, data elements representing a patient's healthcare expenses may be stored and updated to ensure the patient's deductible is satisfied before payment is made for a claim related to that patient. Before the database is updated, however, the destination executable application 134 verifies that the message is completely successfully processed. Otherwise, the repository 118 stores data identifying errors of a type encountered by the destination executable application 134 in processing data elements of individual data records for storage in a database. These types of errors indicate at least one of: (a) a data element format incompatibility, (b) a missing mandatory data element and (c) a surplus data element.

Other error representative data may also be stored in the repository 118. For example data may be stored in the repository 118 which associates the error encountered by the particular destination executable application 134 with the first message and with the particular destination executable application 124. Similar data may be stored in the repository 118 which associates a source executable application 124 which generated the first message with the error encountered by the particular destination executable application 134. The data identifying the error encountered by the particular destination executable application 134 during partially successfully processing data in the first message comprises an error representative code, and the data identifying the first message includes the message identifier.

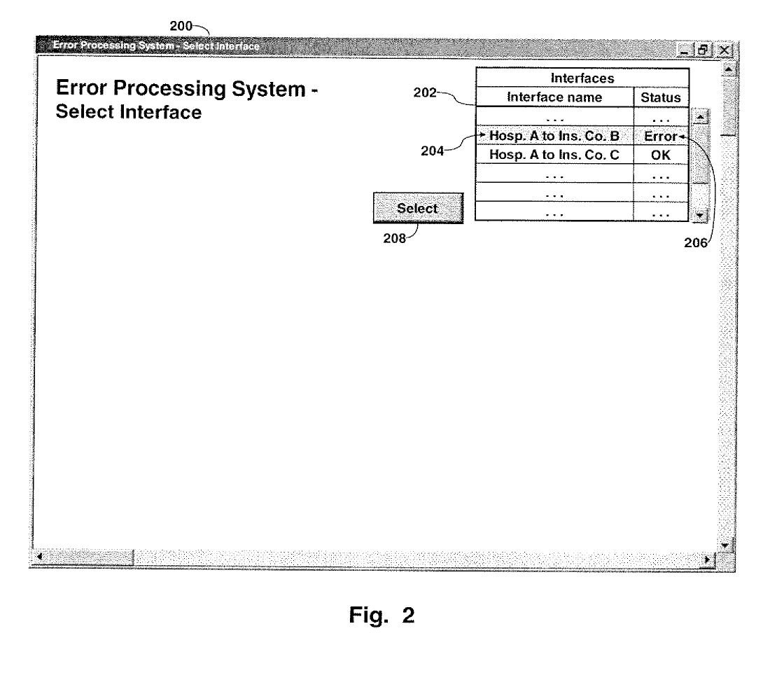

FIG. 2 through FIG. 7 illustrate screen displays for a user interface according to principles of the present invention. FIG. 2 illustrates a UI screen display 200 generated as a part of the UI used by the error processing system 1 (FIG. 1). The UI screen display 200 is displayed when the error processing system 1 is activated. In FIG. 2, a list box 202 displays a list of interfaces for which data is stored in the repository 118. As used herein, an interface is a link between two specific processing systems over which messages are communicated. For example, because data is stored in the repository 118 representing transaction messages communicated between the Hospital A (Hosp. A) processing system 20 and the Insurance Company B (Ins. Co. B) processing system 30, an entry 204 is displayed in the list box 202 representing that interface. It is also possible for the data in the repository 118 representing the transactions sent through the listed interfaces to be scanned to determine if there are transactions for which errors have occurred, and to provide status data 204 for the respective interfaces. A user may sort the entries in the list box 202 by the status, so that interfaces with errors are grouped together. The user may then select a desired interface in a manner described below. The error processing system 1 saves data representing the selected interface so future operations, described below, are directed to that interface. In addition, search parameters are reset.

The user manipulates the input devices 113 (FIG. 1) to select a desired interface. For example, a user may manipulate a pointing device, such as a mouse, to point to a desired interface 204 and single click to highlight that interface. The user may then manipulate the pointing device to point to a “Select” button 208 and single click to select the highlighted interface 204. Alternatively, the user may double click the entry in the list box 202 representing desired interface to select the desired interface 204. The keyboard may also be used, for example, by activating the “Tab” key until the list box 202 is activated, then using the “Up” and “Down” buttons to highlight a desired interface, e.g. 204. Then the “Return” key may be activated to select the highlighted interface. Other methods of using the mouse and/or keyboard and/or other input device may also be used, for example: activating a menu or submenu; right clicking to perform a context selection; using “hotkey” keyboard keys, and so forth. Such alternative methods of interfacing with UI screen images are well known to programmers and users and will not be described below. Instead, the description will refer to the functions performed by these alternative user actions.

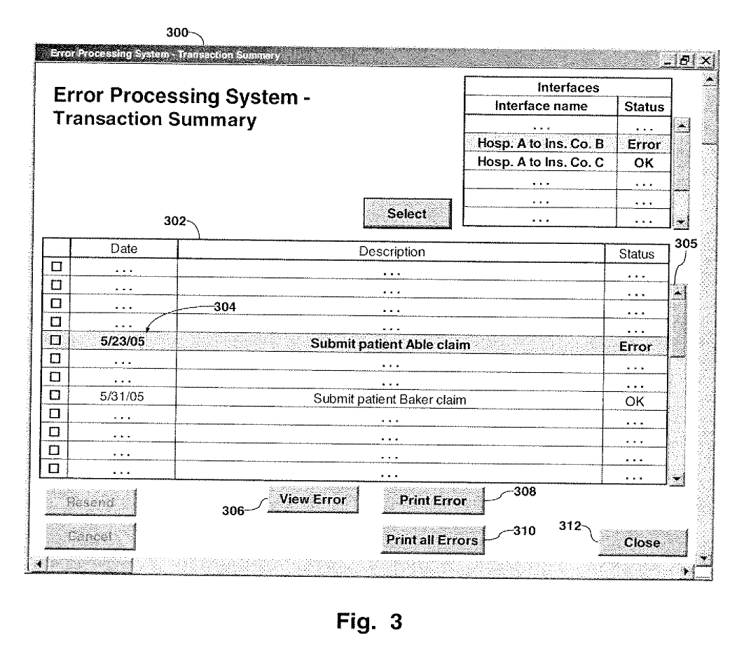

When the user selects a desired interface, as described above, the repository 118 (FIG. 1) is searched to produce a list of transactions initiated by messages passed over that interface is displayed. FIG. 3 illustrates a screen display 300 of such a list. In FIG. 3, a list box 302 displays the list of transactions which were communicated over the selected interface. In the illustrated screen display 300, the date, description and status of the listed transactions are displayed. A user may sort the list by date, description or status in a known manner (e.g. by clicking the label at the top of the column). In FIG. 3, an entry 304 in the list of transaction in the list box 302 is indicated as being communicated on May 23, 2005, representing the submission of an insurance claim 30 for patient Able and has an error associated with it. A single page of transactions is displayed at a time. However, scroll bar 305 permits a user to view other transactions communicated over the selected interface. The list box 302 remains displayed until the user activates the “Close” button 312, or exits the executable application.

When a user highlights an entry in the list box 302 for which an error is indicated, as illustrated in FIG. 3, buttons 306, 308 and 310 are enabled. If the user activates the “Print Error” button 308, a copy of the error associated with the highlighted transaction is printed on a printer (not shown) coupled to the error processing system 10 (FIG. 1). If the user activates the “Print All Errors” button 310, a list of the error associated with the highlighted transaction and all sub-errors associated with that error (i.e. errors associated destination executable applications in other processing systems or within the same processing system) is printed on the printer coupled to the error processing system 10. If the user activates the “View Error” button 306, the UI displays a display screen listing the error or a list of errors associated with the highlighted transaction.

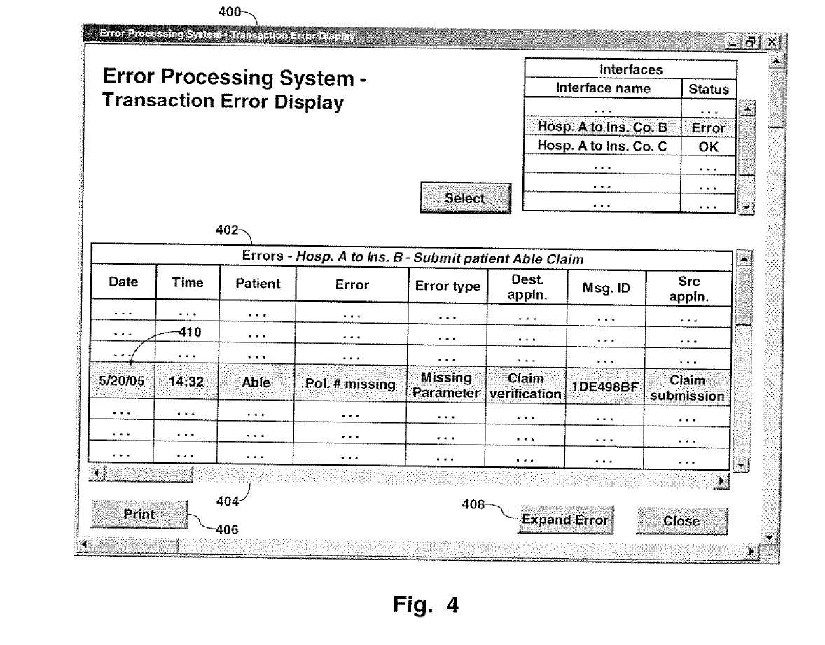

FIG. 4 is a UI screen display 400 displaying the error or errors associated with the transaction highlighted in FIG. 3. In FIG. 4, a list box 402 displays a plurality of rows representing respective errors associated with the transaction selected in the display screen 300 of FIG. 3. For each row, the list box 402 displays a plurality of columns containing data elements associated with respective errors. Respective columns in the list box 402 display data representing the date and time the error was encountered; the patient identification information, the error description, the type of error, the destination executable application, the message identifier and the source executable application. Other data may be displayed, and may be viewed by manipulating the scroll bar 404.

A user may highlight an error listed in list box 402. In FIG. 4, error 410 is highlighted. If the user activates the “Print” button, a copy of the error data elements is printed on the printer coupled to the error processing system 10 (FIG. 1). If the “Expand Error” button 408 is activated, then a UI display screen including more detailed information about the error is displayed.

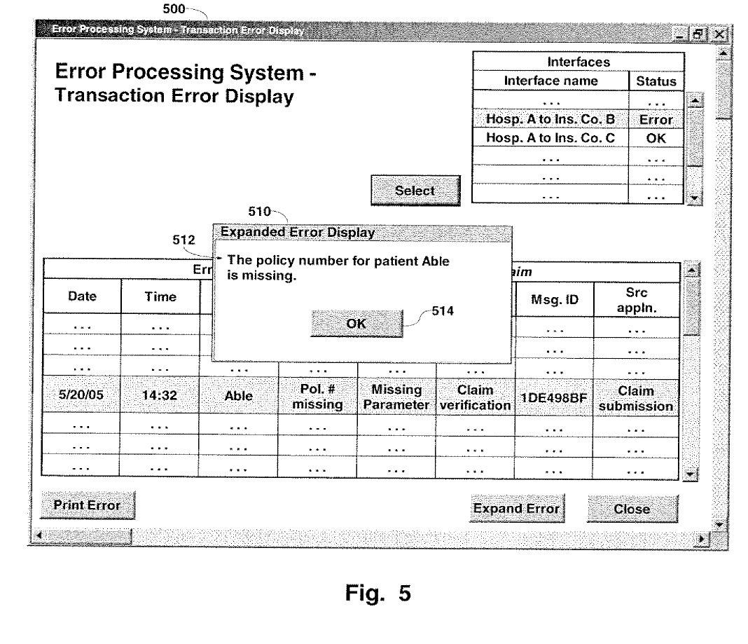

FIG. 5 is a UI screen display 500 illustrating display of expanded error information. In FIG. 5, the UI screen display 500 includes dialog box 510 displaying expanded error information. The dialog box 510 includes a message 512, further describing the error, and an “OK” button 514. One skilled in the art understands that such a dialog box may include other UI display elements, including list boxes, text boxes, tables, scroll bars, etc. to display further information about the error highlighted in FIG. 4.

Referring again to FIG. 1, the error processing system 10 includes a search processor executable procedure 114a. When activated, i.e. executed by the processor 112, the search processor executable procedure 114a conditions the error processing system 10 to operate as a search processor on the data in the repository 118. The error processing system 10, when operating as a search processor, initiates a search of the repository 118 to provide search results identifying particular errors associated with user entered search criteria. These criteria includes: (a) a date range, (b) a destination executable application identifier, and/or (c) a patient identifier. The user may enter other data as search criteria, such as: (a) a source executable application identifier, (b) an error type identifier and/or (c) a time range. More generally, it is possible to perform a search on any data elements stored in the repository 118. When the search has been performed, the display processor 115, as a part of the user interface, initiates generation of data representing a display image including data representing the search results.

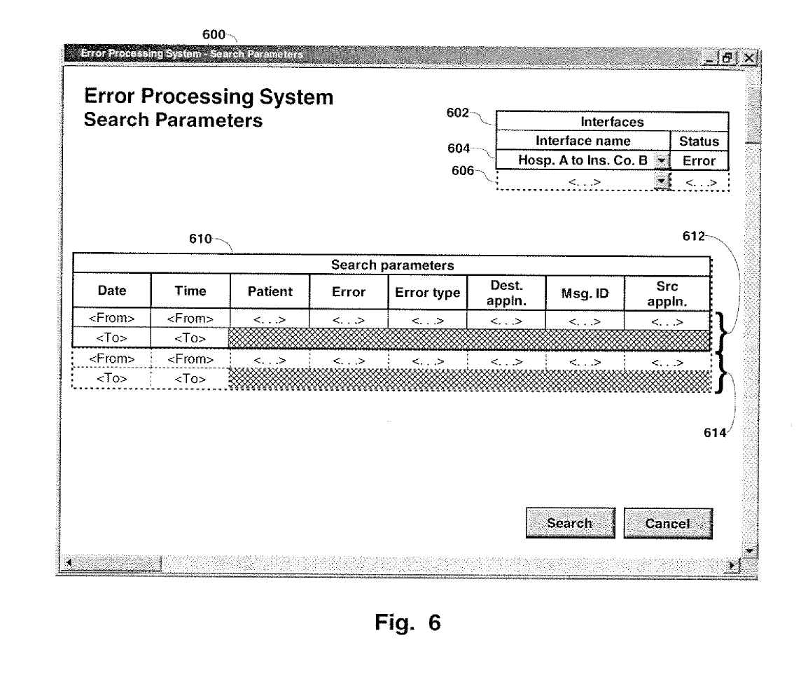

FIG. 6 is a UI screen display illustrating UI elements used to gathering search criteria used for searching the data in the repository 118 (FIG. 1). In FIG. 6, a first dialog box 602 may be used to specify a particular interface. A first row includes data representing the interface previously selected using the UI illustrated in FIG. 2, namely the interface is “Hosp. A to Ins. Co. B” and the status is “Error”. The user may allow these selections to remain, may delete this information to eliminate interface as a search criterion, or may select a different interface and/or status by entering that data into the corresponding text boxes in row 604. The down arrow to the right of the interface selection box permits the user to select an interface from among the available interfaces. If a user wants to specify two or more interfaces as search criteria, the user conditions the UI to display a second row 606, illustrated in phantom in FIG. 6. The user may specify a second interface and/or status by entering the desired data into the corresponding text boxes in row 606, as indicated by “< . . . >”.

The UI screen display 600 also includes a list box 610 which may be used to specify the other search criteria. A first set of two rows 612 may be used by a user to specify a date range by entering data into the “<From>” and “<To>” boxes in the “Date” and “Time” columns. Other search criteria, e.g. “Patient”, “Error”, “Error Type”, destination executable application (“Dest. Appln.”), message ID (“Msg. ID”), search executable application (“Src. Appln.”), and so forth, may be entered by the user into the corresponding text boxes in the rows 612, as indicated by “< . . . >”. If a user wants to specify two or more sets of data as search criteria, the user conditions the UI to display a second set of two rows 614, illustrated in phantom in FIG. 6. The user may specify a desired data by entering the desired data into the corresponding text boxes in row 606, as indicated by “< . . . >”.

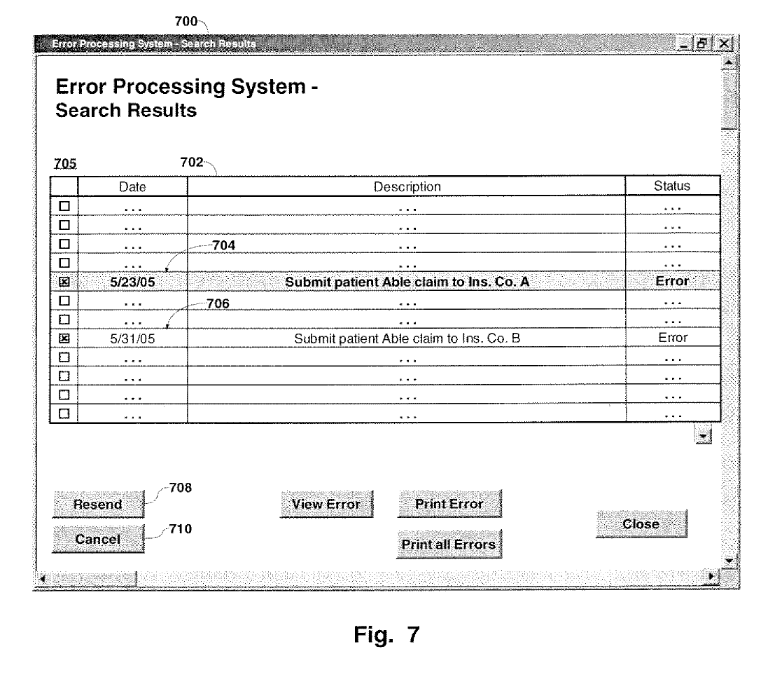

The search processor executable procedure 114b (FIG. 1) searches the data in the repository 118 to find records having data matching the search criteria. Such matching data may be displayed in a UI image. FIG. 7 is a display screen 700 displaying search results. In FIG. 7, a list box 702 displays data corresponding to the transactions meeting the search criteria. The user may print the error associated with a selected transaction 704, print all errors associated with a selected transaction 704, and view a UI screen display (FIG. 4) displaying data corresponding to the error associated to the selected transaction.

The system described above permits a user at a central location, i.e. at the error processing system 10, to analyze the source of errors and to determine how to correct the errors. In some circumstances, to correct an error, a transaction, or set of transactions may simply need to be resent. In FIG. 7 a set of check boxes is displayed in a column 705. A user may select one or more transactions to resend by checking the check boxes in column 705. For example, in FIG. 7, transactions 704 and 706 have been checked. A user may resend the checked transaction by clicking the “Resend” button 708. In response, the checked transactions are resent. If the user decides to not resend the checked transactions, the “Cancel” button 710 may be clicked. In response, no transactions are sent and the check boxes in column 705 are cleared.

What is claimed is:

1. In a system for communicating messages from a plurality of source executable applications to a plurality of destination executable applications, an error processing system comprising:
a repository for centrally storing data identifying errors encountered by a plurality of different destination executable applications in processing data in messages from one or more source executable applications, an identified error of an individual destination executable application being encountered during partially successfully processing data in a first message received from a source executable application; and
a user interface for initiating generation of data representing a single display image including data identifying:
at least one error encountered by a particular destination executable application during partially successfully processing data in a first message,
said first message, and
said particular destination executable application.

2. A system according to claim 1, wherein:
a plurality of different destination executable applications process data in said first message; and
an error encountered by at least one of said plurality of different destination executable applications results in partially successfully processing the data in said first message.

3. A system according to claim 2 wherein said plurality of different destination executable applications processing data in said first message execute in a first processing system.

4. A system according to claim 2 wherein a first subset of said plurality of different executable applications processing data in said first message execute in a first processing system and a second subset of said plurality of different executable applications processing data in said first message execute in a second processing system.

5. A system according to claim 1 wherein:
a plurality of different destination executable applications process data in said first message;
a first subset of said plurality of different destination executable applications processing data in said first message execute in a first processing system;
at least one destination executable application in said first subset of said plurality of different destination executable applications communicates a second message to a second processing system;
a second subset of said plurality of different destination executable applications processing data in said first message execute in said second processing system; and
an error encountered by at least one of said plurality of different destination executable applications results in partially successfully processing the data in said first message.

6. A system according to claim 1, wherein said repository stores data identifying errors of a type encountered by a destination executable application in processing data elements of individual data records for storage in a database, said type of errors indicating at least one of: (a) a data element format incompatibility, (b) a missing mandatory data element and (c) a surplus data element.

7. A system according to claim 1, wherein said repository associates said at least one error encountered by said particular destination executable application with said first message and with said particular destination executable application.

8. A method according to claim 7, wherein said repository associates a source executable application of said first message with said at least one error encountered by said particular destination executable application.

9. A system according to claim 7, wherein:
said data identifying said at least one error encountered by a particular destination executable application during partially successfully processing data in a first message comprises an error representative code; and
said data identifying said first message comprises a message identifier.

10. A system according to claim 1, further comprising:
a search processor for initiating a search of said repository to provide search results identifying particular errors associated with user entered search criteria comprising at least one of, (a) a date range, (b) a destination executable application identifier and (c) a patient identifier; wherein:
said user interface initiates generation of data representing a display image including data representing said search results.

11. A system according to claim 10, wherein said user entered search criteria comprise at least one of, (a) a source executable application identifier, (b) an error type identifier and (c) a time range.

12. A system according to claim 1, wherein a message comprises an HL7 (HealthLevel 7) protocol compatible transaction.

13. A system according to claim 1, further comprising an acquisition processor for acquiring said data identifying errors encountered by said plurality of different destination executable applications for central storage in said repository.

14. A system according to claim 13, wherein said data identifying errors encountered by said plurality of different destination executable applications is derived from individual error logs associated with corresponding individual destination executable applications.

15. A system according to claim 14 wherein when an error is encountered by one of said plurality of destination executable applications processing data in said first message, said one of said destination executable applications stores data representing said error in said individual error log associated with the one of said plurality of destination executable applications.
